(19) United States
(12) Patent Application Publication
(10) Pub. No.: US 2011/0064026 A1
(43) Pub. Date: Mar. 17, 2011

(54) METHOD FOR OPERATING A WIRELESS SENSOR NETWORK AND SENSOR NODE

(76) Inventors: Christoph Niedermeier, Munchen (DE); Norbert Vicari, Munchen (DE); Joachim Walewski, Unterhaching (DE); Andreas Zeidler, Munchen (DE)

(21) Appl. No.: 12/922,185

(22) PCT Filed: Mar. 12, 2009
(86) PCT No.: PCT/EP09/52917

§ 371 Date: Nov. 29, 2010

(30) Foreign Application Priority Data
Mar. 17, 2008 (DE) 10 2008 014 633.1

(51) Int. Cl. H04W 84/00

(52) U.S. Cl. 370/328

(57) ABSTRACT

In a method for operating a wireless sensor network (1) with a plurality of sensor nodes (2-4), which are suitably set up to transmit data by nondirectional radio transmission, a selected set containing at least one sensor node (2) can be selectively moved from a first operating state into a second operating state by a spatially delimited first operating state control signal (17), with the sensor node (2-4) in the first operating state not being able to receive control data by nondirectional radio transmission and in the second operating state, being able to receive and process control data by nondirectional radio transmission. Furthermore, a sensor node can be suitably configured to implement the method.

### CROSS-REFERENCE TO RELATED APPLICATIONS

This application is a U.S. National Stage Application of International Application No. PCT/EP2009/052917 filed Mar. 12, 2009, which designates the United States of America, and claims priority to DE Application No. 10 2008 014 633.1 filed Mar. 17, 2008. The contents of which are hereby incorporated by reference in their entirety.

### TECHNICAL FIELD

The invention exists in the field of network technology and relates to a method for operating a wireless sensor network and a sensor node of a sensor network which is suitably configured to implement the method.

### BACKGROUND

Sensor networks are increasingly used for various monitoring tasks in complex environments, such as large-scale industrial plants, power plants, ships, aircraft and motor vehicles. During use, wireless sensor networks with a plurality of wirelessly communicating sensor nodes have proven to be particularly practical since the sensor nodes can optionally be positioned at various points.

Wireless sensor networks are managed by a network management, which is generally implemented in a wireless control station (base station) which communicates with the sensor nodes. The data scanned by the sensor nodes is transmitted to the control station and can be transmitted from there to a data processing facility, which is connected to the base station via a data link, for further processing.

The sensor nodes can generally communicate wirelessly with one another and with the base station, which typically takes place by means of nondirectional radio transmission. If a sensor node is herewith located outside of the radio range relative to the base station, data in the multihop method can be routed to the control station by way of several sensor nodes.

Each sensor node of the sensor network includes at least one sensing element for scanning measured values of physical and/or technical measured variables, like for instance air temperature or air pressure, a communication facility for data transmission by means of nondirectional radio transmission, a micro processor-based control facility (CPU=Central Processing Unit) for controlling the sensor node, and an autonomous power supply in the form of a battery or a rechargeable battery.

To install a sensor network, it is necessary for the sensor nodes to be configured—commonly referred to as “engineering” of the sensor network. With the configuration of a sensor node, an identity is assigned hereto, in other words a logical identifier, by way of which the sensor node in the network can be identified and actuated. The identity of a sensor node represents a link to its hardware address (for instance MAC address). Furthermore, the desired functionality is assigned to a sensor node during the configuration, in other words, one or several specific functions, which the sensor node is to execute at a predefinable location. Furthermore, the sensor node is entered (registered) into the network management managing the sensor network during the configuration.

If a sensor network is installed, the configured sensor nodes can be actuated selectively. In this case, it is possible for instance to communicate with the sensor nodes selectively on site with the aid of a wirelessly communicating mobile control device, in the form of a PDA (PDA=Personal Digital Assistant) for instance. Such a control device is also referred to as an HMI (Human Machine Interface).

Practice has now shown that the configuration of the sensor nodes is associated with a considerable amount of work during the installation and maintenance of wireless sensor networks. Since a clear assignment of data traffic between a specific sensor node and a mobile control device is only possible with configured sensor nodes, a non-configured sensor node can then only be selectively actuated by means of a nondirectional radio transmission, if it is guaranteed that no further sensor node is located in the radio range. For this reason, sensor nodes were until now configured outside of the radio range relative to other sensor nodes by way of a programming board by means of nondirectional radio transmission, since there is the risk on site that further sensor nodes located in the radio range are actuated. This procedure is however complicated and also increases the risk of sensor nodes being mixed up after configuration and being assembled at incorrect (not provided) assembly sites. A check as to whether or not a sensor node was mounted on the provided site is only indirectly possible by way of detecting measured variables. To prevent assembly of sensor nodes at incorrect sites, it would be desirable for the configuration of the sensor nodes to be able to take place on site by using a mobile control device by means of nondirectional radio transmission.

In already installed sensor networks, it may occasionally occur that sensor nodes have to be repaired or replaced, be it that a sensing element has failed or that the battery is empty. This maintenance measure generally requires a new or initial configuration of the repaired or replaced sensor node, which can however not take place on site due to the afore-cited problem. In the case of expanded sensor networks, in large-scale industrial plants for instance, this may in some instances result in the service technician having to cover very large distances, in order to configure the sensor nodes outside of the radio range of other sensor nodes, as a result of which working hours are lost unnecessarily. It would be desirable if the configuration of the sensor node could be selectively implemented on site by means of nondirectional radio transmission, particularly in the case that a sensor node can already be brought back into a functional state by means of a simple onsite measure, for instance by replacing a measuring element or the battery, which can, if necessary, also be implemented without dismantling the sensor node.

### SUMMARY

According to various embodiments, a method for operating a wireless sensor network can be provided, which also then enables a selective configuration of a sensor node by means of nondirectional radio transmission if further sensor nodes are in the radio range.

According to an embodiment, in a method for operating a wireless sensor network comprising a plurality of sensor nodes, which are suitably configured to transfer data by means of nondirectional radio transmission, a selected set containing at least one sensor node can be moved selectively from a first operating state into a second operating state by means of a spatially delimited first operating state control signal, with the sensor nodes in the first operating state not being able to receive or at least process control data by means of nondirectional radio transmission and in the second operating state being able to receive and process control data by means of nondirectional radio transmission.

According to a further embodiment, the first operating state control signal can be sent in the form of directional electromagnetic radiation. According to a further embodiment, the first operating state control signal can be sent in the form of directional radio transmission. According to a further embodiment, the first operating state control signal can be sent in the form of a directional light beam. According to a further embodiment, the first operating state control signal can be sent in the form of a diffuse electromagnetic radiation in an environment which spatially delimits the electromagnetic radiation. According to a further embodiment, the first operating state control signal can be sent in the form of a diffuse light transmission in an optically delimited environment. According to a further embodiment, the first operating state control signal can be modulated with a selectable control signal identifier, which is demodulated by a sensor node receiving the first operating state control signal, with a sensor node being moved into the second operating state if the first operating state control signal is provided with the control signal identifier and not being moved into the second operating state if the first operating state control signal is not provided with the control signal identifier. According to a further embodiment, a spectral characteristic of the first operating state control signal transmitted in the form of visible light can be determined in a sensor node, with a sensor node being moved into the second operating state, if the spectral characteristic of the first operating state control signal corresponds to a presettable spectral characteristic of the first operating state control signal and not being moved into the second operating state if the spectral characteristic of the first operating state control signal does not correspond to the presettable spectral characteristic of the first operating state control signal. According to a further embodiment, electrical energy in a sensor node can be obtained from the first operating state control signal transmitted in the form of light. According to a further embodiment, the first operating state control signal can be sent by means of directional sound waves. According to a further embodiment, the first operating state control signal can be sent in an acoustically delimited environment by means of nondirectional sound waves. According to a further embodiment, upon receipt of the first operating state control signal, a sensor node may transmit a confirmation signal by means of nondirectional radio transmission. According to a further embodiment, the first operating state control signal can be sent by a signal sensor in the form of a signal pulse and that a time-resolved receipt of the confirmation signal takes place by the signal sensor. According to a further embodiment, a sensor node may remain in the second operating state for a presettable first time frame and can be automatically moved into the first operating state after the first time frame has lapsed. According to a further embodiment, a sensor node in the second operating state can be moved into the first operating state upon receipt of a first operating state control signal. According to a further embodiment, the sensor nodes of the sensor network can be moved from a third operating state into the first operating state by a second operating state control signal, with the sensor nodes in the third operating state not being able to receive or at least process the first operating state control signal and in the first operating state being able to receive and process the first operating state control signal. According to a further embodiment, a sensor node may remain in the first operating state for a presettable second time frame and is automatically moved into the third operating state after the second time frame has lapsed. According to a further embodiment, a sensor node in the first operating state can be moved into the third operating state upon receipt of a second operating state control signal. According to a further embodiment, the sensor nodes can be changed over between a sensor-passive state, in which they do not scan data, and a sensor-active state, in which they scan data, by means of the first operating state control signal. According to a further embodiment, the first operating state control signal can be sent by a mobile control device as a signal sensor. According to a further embodiment, the second operating state control signal can be sent by a mobile control device as a signal sensor.

According to another embodiment, a sensor node can be provided with at least one sensor for scanning data, a transmitter-receiver for transmitting data by means of nondirectional radio transmission and a microprocessor-based control facility for controlling the sensor node, wherein the control facility is suitably configured to implement a method as described above.

### BRIEF DESCRIPTION OF THE DRAWINGS

The invention is now explained in more detail with the aid of an exemplary embodiment, with reference being made to the appended Figures.

FIG. 1 schematically illustrates a sensor network, the sensor node of which is configured with a mobile control device;

FIG. 2 shows a schematic flow chart for configuring the sensor nodes of the sensor network in FIG. 1.

### DETAILED DESCRIPTION

In accordance with various embodiments, a method for operating a wireless sensor network is shown. A sensor network suited to implementing the method according to various embodiments includes a plurality of wirelessly communicating sensor nodes. These can wirelessly exchange data with one another and with a base station, controlled by a network management implemented in the sensor network. The data scanned by the sensor nodes can be transmitted to the base station and analyzed there or transferred to a further data processing facility for its processing.

Each sensor node of the sensor network includes at least one measuring element for scanning measured values of physical and/or technical measured variables, a communication facility for transferring data by means of nondirectional radio transmission between the sensor node and other sensor nodes and/or the base station, a microprocessor-based control facility for controlling the functionality of the sensor node, and an autonomous power supply in the form of a battery and/or rechargeable battery.

The method according to various embodiments for operating the sensor network also provides for a selected set of sensor nodes of the sensor network which contains at least one sensor node to be able to be selectively moved from a first operating state into a second operating state by means of a wirelessly transmitted first operating state control signal which is generated by a signal sensor, said operating state control signal being spatially delimited such that it only strikes the sensor node contained in the selected set.

The sensor nodes are set up such that they can only receive and process control data in the second operating state by means of nondirectional radio transmission, while in the first operating state, they are not able to receive or at least process control data by means of nondirectional radio transmission. Since sensor nodes often only awaken for a few seconds a few times per day and are otherwise in an energy-saving standby state, the first operating state control signal can be used as a prompt signal, in order to waken a sensor node outside of the provided sequence.

The first operating state control signal is used to control operating states of the sensor nodes, in other words to change over the possible operating states of the sensor nodes. The first operating state control signal therefore differs in its characteristics from sensor data which is transmitted between the sensor nodes and/or between a sensor node and the base station.

The control data transmitted to the sensor nodes by means of nondirectional radio transmission is used to control the functionality of a sensor node, with, in particular, the configuration of a sensor node mentioned in the introduction, in other words the assignment of an identity and the entry of a sensor node into the network management, can take place by means of the control data. The control data thus differs in its characteristics from the first operating state control signal and sensor data, which is transmitted between the sensor nodes and/or between a sensor node and the base station.

The method according to various embodiments firstly enables a selective transmission of control data to a sensor node which is already assembled at a predeterminable site (assembly point) but not yet configured, by means of nondirectional radio transmission, for instance in order to configure the sensor node on site, without herewith risking further sensor nodes in the radio range of the radio transmission being actuated.

In an embodiment of the method, the first operating state control signal is sent by means of directional electromagnetic radiation, which is a transmission of directional radar signals or a transmission of directional radio signals (directional radio) for example, for instance with a frequency of 60 GHz, or a transmission of directional light-optical signals (light radiation) in the visible wavelength range.

If a transmission of the first operating state control signal takes place by means of directional radio for instance, the communication facility can be used for wireless radio transmission of the sensor nodes and also for receiving the first operating state control signal. Alternatively, it is possible for the sensor nodes to be provided with a separate receiving facility for receiving the first operating state control signal transmitted by means of directional radio.

This embodiment of the method enables a particularly simple technical realization of the method, with it being possible for the electromagnetic radiation generated by a signal sensor, for instance a mobile control device, to be easily directed at a selectable sensor node in order to move the sensor node selectively from the first operating state into the second operating state.

If the first operating state control signal is transmitted in the form of a directional light-optical signal, for instance in the form of a laser beam or bundled light beam, the arrival of the directional light optical signal at the selected sensor node can advantageously be optically monitored.

With an alternative embodiment of the method, the first operating state control signal is sent instead of a directional electromagnetic radiation by means of nondirectional (diffuse) electromagnetic radiation, with the electromagnetic radiation being sent within an environment which spatially delimits the electromagnetic radiation so that the electromagnetic radiation is also spatially delimited in this case and the sensor nodes located within the spatially delimited environment can be selectively moved from the first operating state into the second operating state.

For instance, the first operating state control signal is sent in an optically delimited environment by means of diffuse light (for instance a ceiling lighting), whereby all sensor nodes within the optically delimited environment can be selectively moved into the second operating state.

This embodiment of the method enables a further particularly simple technical realization of the method, in which the sensor nodes within the optically delimited environment can be moved from the first operating state into the second operating state. An optically delimited environment is then realized if a desired selected set of sensor nodes is optically shielded from the sensor nodes.

In the event that the first operating state control signal is sent in the form of a directional light beam or alternatively in the form of nondirectional (diffuse) light in an optically delimited environment, the sensor nodes for receiving the light optical signal are provided with an optoelectronic converter (e.g. photodiode).

In the event that the first operating state control signal is sent in the form of a directional light beam or alternatively in the form of nondirectional (diffuse) light in an optically delimited environment, it may also be advantageous if the first operating state control signal is modulated with a selectable control signal identifier, which can be demodulated by a sensor node receiving the first operating state control signal. The sensor nodes are herewith configured such that a sensor node is then only moved into the second operating state if the first operating state control signal is provided with the control signal identifier and not into the second operating state if the first operating state control signal is not provided with the control signal identifier. Such a modulation advantageously prevents random light fluctuations or regular light modulations, as are typical for instance for fluorescent lamps, from being incorrectly interpreted as a first operating state control signal. A modulation of the light of fluorescent lamps takes place at certain frequencies. If the light is modulated onto a subcarrier with a frequency that differs therefrom, this can be received and demodulated in an interference free fashion. A further method which is suited hereto is CDMA (Code Division Multiple Access) for instance.

In a further embodiment of the method, a spectral characteristic of the first operating state control signal is determined instead of a modulated signal identifier, with a sensor node only then being moved into the second operating state if the spectral characteristic of the first operating state control signal corresponds to a presettable spectral characteristic for the first operating state control signal and on the other hand not being moved into the second operating state if the spectral characteristic of the first operating state control signal corresponds to the presettable spectral characteristic for the first operating state control signal. In this case, the spectral characteristics of light are used to prevent this from being incorrectly interpreted as a first operating state control signal. Fluorescent lamps in the near infrared spectral range thus emit comparatively weakly, so that a communication with near infrared light can take place in a largely interference-free fashion.

In a further embodiment of the method, electrical energy in a sensor node is obtained from the first operating state control signal. This is advantageous in that a sensor node can be supplied externally with energy in order to charge its battery. The sensor nodes are to this end provided with means (e.g. solar cells) for obtaining electrical energy from the first operating state control signal transmitted in the form of light. If the first operating state control signal is transmitted for instance in the form of a directional light beam modulated with a signal identifier, the DC part (DC=Direct Current) of the light current can be used to generate electrical energy and its AC part (AC=Alternating Current) can be used to transfer information.

In a further embodiment of the method, the first operating state control signal is sent by means of directional sound waves. Alternatively, the first operating state control signal can likewise be sent in an acoustically delimited environment by means of nondirectional sound waves. A further simple technical realization of the method is herewith enabled. The sensor nodes are in this case provided with an acousto-electronic converter for receipt of the acoustic signal.

In a further embodiment of the method, upon receipt of the first operating state control signal, a sensor node transmits a confirmation signal by means of nondirectional radio transmission. This measure ensures that a sensor node has actually been moved from the first operating state into the second operating state in order then to implement a configuration of the sensor node by means of nondirectional radio transmission for instance. The first operating state control signal is herewith particularly advantageously sent from a signal sensor (for instance a mobile control device) in the form of a very short signal pulse, and the confirmation signal is received by the signal sensor in a time-resolved fashion. This measure advantageously distinguishes whether the first operating state signal has reached a sensor node directly or indirectly as a result of reflections. To this end, the confirmation signal received first is exclusively processed and subsequently arriving confirmation signals are rejected for instance. The spreading spectral modulation technology known per se can also be used here.

In a further embodiment of the method, a sensor node for a presettable first time frame remains in the second operating state and is automatically moved into the first operating state after the first time frame has lapsed. It is herewith possible for a sensor node to only be activated for a selectable time frame for receiving control data by means of nondirectional radio transmission.

With an alternative embodiment of the method, a sensor node in the second operating state is moved into the first operating state upon receipt of a further first operating state control signal. This measure enables a sensor node to be easily inactivated for the receipt of control data by means of nondirectional radio transmission.

With a further embodiment of the method, the sensor nodes of the sensor network can be moved from a third operating state into the first operating state by a second operating state control signal transmitted by means of nondirectional radio transmission, with the sensor nodes in the third operating state not being able to receive or at least process the first operating state control signal and in the first operating state being able to receive and process the first operating state control signal. With this embodiment of the method, it may be advantageous if a sensor node remains in the first operating state for a presettable second time frame and is automatically moved into the third operating state after the second time frame has lapsed. It is alternatively likewise possible for a sensor node in the first operating state to be moved into the third operating state upon receipt of a second operating state control signal. This measure enables the sensor node to remain in the first operating state only for a limited time frame.

With a further embodiment of the method, the sensor function of sensor nodes can be switched on or off by the first operating state control signal so that a sensor node only awaking during relatively short time spans can advantageously be activated outside of the provided sequence in order to scan data.

With a further embodiment of the method, the first operating state control signal and/or the second operating state control signal is transmitted by a mobile control device as a signal sensor, which is advantageous in terms of a very simple onsite configuration of sensor nodes.

The various embodiments also extend to a sensor node of a sensor network, which is provided with at least one measuring element (sensor) for scanning data, a communication facility (transmitter-receiver) for transmitting data by means of nondirectional radio transmission and a microprocessor-based program-controllable control facility for controlling the sensor node, in which the control facility is suitably configured to implement a method as described above.

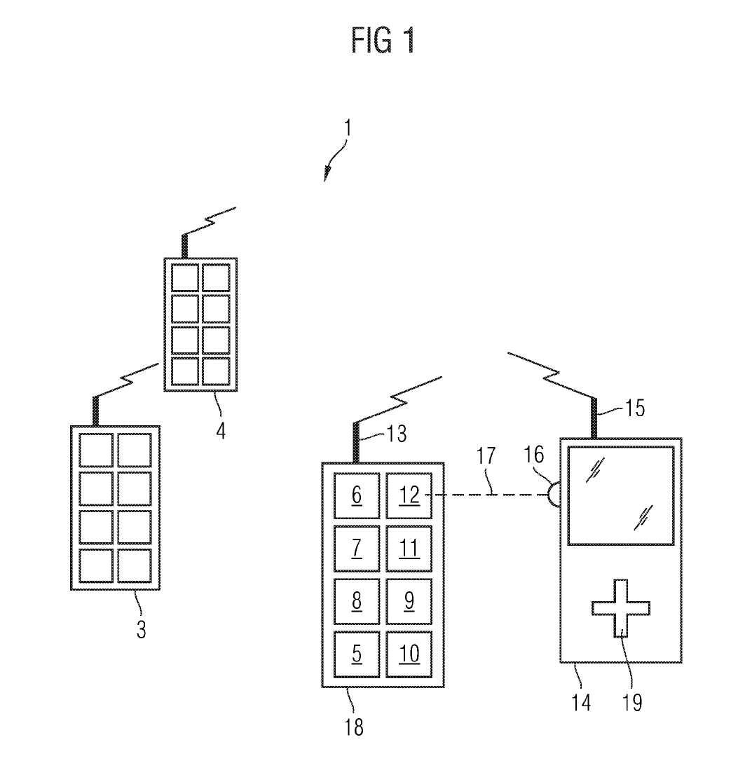

FIG. 1 shows a schematic representation of a sensor network referred to overall with the reference numeral 1. The sensor network 1 includes a plurality of sensor nodes with the same structure, of which only three adjacent sensor nodes 2-4 are shown in FIG. 1. The sensor nodes 2-4 are assembled on different sites of a large-scale industrial system for instance, which is not shown in more detail in FIG. 1.

Each sensor node 2-4 contains several measuring elements (sensors) 5 in a housing 18, which are able to scan measured values of physical and/or technical measured variables, here for instance air temperature and air humidity. Furthermore, each sensor node 2-4 contains a program-controlled, microprocessor-based control facility (CPU) 7 for controlling the functions of the sensor node. The CPU 7 operates together with two storage facilities, a RAM (Random Access Memory) 8 and a non-volatile flash memory 9. Furthermore, each sensor node 2-4 is provided with a transceiver (transmitter-receiver) 6 in order to transmit data by means of nondirectional radio transmission by way of a first radio antenna 13. A transmission frequency for the radio transmission amounts to 60 GHz for instance. Each sensor node 2-4 is provided with electrical energy by way of an autonomous power supply in the form of a battery 10.

The sensor nodes 2-4 of the sensor network 1 can exchange data with one another and with a base station and/or mobile control device 14 (not shown in FIG. 1) in order to configure the sensor node by means of nondirectional radio transmission by way of the first radio antenna 13.

A configuration of the sensor nodes 2-4 can take place on site by means of the mobile control device 14, which can communicate wirelessly with the sensor nodes 2-4 and is for this purpose provided with a transceiver (not shown in more detail) which enables a nondirectional radio transmission by way of a second radio antenna 15.

To selectively actuate a sensor node, the mobile control device 14 is provided with a light beam generating facility, here in the form of a laser diode 16, by means of which a visible laser beam 17 can be generated with a wavelength in a wavelength range of 640 nm to 660 nm for instance.

Each sensor node 2-4 is correspondingly provided with a light beam receiving facility, here in the form of a photodiode 12, by means of which the laser beam 17 sent by the control device 14 can be received and converted into an electrical signal. The photodiode 12 can be controlled by a control interface 11 connected to the CPU 7 via a data link.

If the mobile control device 14 is positioned such that the laser beam 17 generated by the control device 14 strikes the photo diode 12 of a desired sensor node, the sensor node can be selectively actuated. FIG. 1 shows this by way of example for a first sensor node 2.

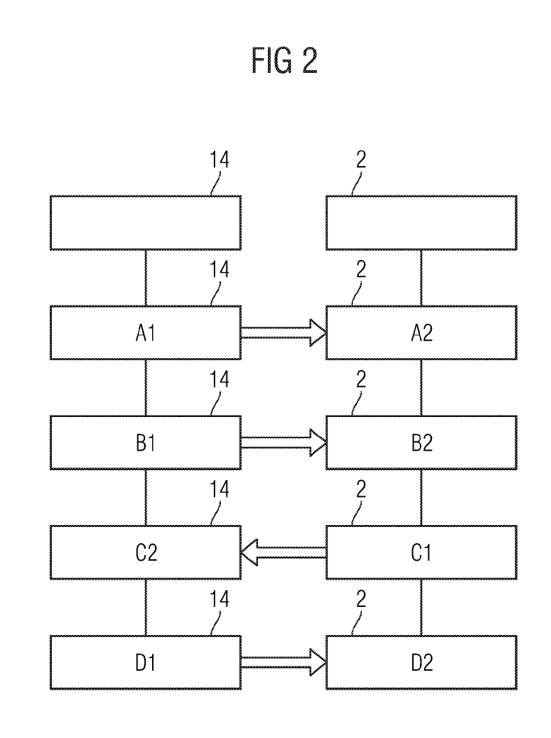

An exemplary embodiment of the method is now described, with reference being made in particular to FIG. 2.

In the exemplary embodiment, a configuration of the sensor nodes 2-4 takes place which is described on the basis of a configuration of the first sensor node 2. All sensor nodes 2-4 are found in the radio range relative to the mobile control device 14. In the schematic flow chart in FIG. 2, the left boxes each relate to method steps which are executed by the mobile control device 14, whereas the right boxes each relate to method steps which are executed by the first sensor node 2.

The sensor nodes of the sensor network 1 are programmed such that they only awaken for a few seconds a few times per day, that they scan data of measured variables in this active state and send data via the active transceiver 6 to the base station. The sensor nodes are otherwise in a passive state, in which they do not scan any data of measured variables and the transceiver 6 is inactive.

Furthermore, all sensor nodes 2-4 at the start of the configuration are in a state (referred to as a third operating state in the introduction to the description), in which the photo diodes 12 thereof are inactivated, in other words, no light-optical signals can be received and processed by way of the photo diodes 12.

To configure the first sensor node 2, the mobile control device initially creates a list of all sensor nodes 2-4 located in the radio range in a preparatory step by means of nondirectional radio transmission. In a further preparatory step, a nondirectional radio signal (referred to as the second operating state control signal in the introduction to the description), is sent from the mobile control device 14 to the sensor nodes 2-4 by means of nondirectional radio transmission by way of the second radio antenna 15, by means of which the sensor nodes 2-4 are moved into a prepared state (referred to as the first operating state in the introduction to the description) in order to receive a light-optical signal, with the photo diodes 12 of the sensor nodes 2-4 being activated for a receipt of a light-optical signal.

A laser beam 17 generated by the laser diode 16 of the mobile control device 14 is then directed at the first sensor node 2, more precisely at its photo diode 12 (step A1). A targeted striking of the laser beam 17 on the photo diode 12 can be optically monitored. The generation of a laser beam 17 by means of the laser diode 16 of the control device 12 can be effected by way of a key switch 19.

The first sensor node 2 receives the laser beam 17 with its photo diode 12 (step A2), which results in the transceiver 6 being activated for a nondirectional radio transmission of control data (here configuration data). The laser beam 17 directed at the photo diode 12 of the first sensor node 2 and received by the photo diode 12 thus acts as a signal (referred to as a first operating state control signal in the introduction to the description), by means of which the first sensor node 2 is moved from its first operating state, in which the transceiver 6 is inactive, into a second operating state, in which the transceiver 6 is activated, but the sensors are not activated.

The first sensor node 2 then sends an identification query (step B1) as a request to transfer an identifier by means of nondirectional radio transmission by way of its first radio antenna 13, said identifier being received by way of the second radio antenna 15 of the transceiver of the mobile control device 14 (step B2).

The first sensor node 2 then transmits an identifier (step C1) stored in the flash memory 9 by means of nondirectional radio transmission by way of its first radio antenna 13, said identifier being received by the transceiver of the mobile control device 14 by way of the second radio antenna 15 (step C2).

This causes the mobile control device 14 to send a sensor node specification (step D1) by means of nondirectional radio transmission by way of its second radio antenna 15, in which sensor node specification it is determined which measuring elements are to be active. A selectable measuring point is also assigned to the first sensor node 2. The sensor node specification is received by the first sensor node 2 (step D2), with the data transmitted here being stored in the flash memory 9.

The described course of events enables the first sensor node 2 to be easily selectively configured onsite without the risk of a second sensor node 3 or a third sensor node 4, which are both in the radio range, accidentally being activated.

A configuration of the second or third sensor node can take place in a similar fashion to the configuration of the first sensor node 2. It is to this end only necessary for the laser beam 17 generated by the control device to be directed at the photodiode 12 of the sensor node to be configured, as a result of which the transceiver 6 of the respective sensor node is activated. All further steps are carried out similarly, as explained above for the first sensor node 2.

In the exemplary embodiment shown for the method, numerous modifications can be performed.

It would therefore be possible for instance for a directional electromagnetic radiation with a different frequency, for instance a radar signal emitted by means of a radar antenna or a directional radio signal emitted by means of a directional radio antenna, to be generated by the control device 14, instead of a light-optical signal generated by a laser diode 16, said electromagnetic radiation being directed at the sensor nodes to be configured in order to move a sensor node from the first operating state into the second operating state. A directional radio signal could be received for instance by the first radio antenna 13 of the sensor nodes 2-4 or alternatively by the separate radio antennae.

It would alternatively also be possible for a directed sound signal to be generated by the control device 14 by means of an acoustic signal sensor, said sound signal being directed at the sensor node to be configured in order to move a sensor node from the first operating state into the second operating state. The sensor nodes would to this end be provided with acousto-electronic converters for receiving sound waves and their conversion into electrical signals.

Alternatively, it would also be possible for the sensor nodes to be moved from the first operating state into the second operating state not by means of directional electromagnetic radiation but instead by means of nondirectional (diffuse) electromagnetic radiation. The prerequisite here is that the selectively configuring sensor nodes are within an environment which spatially delimits the electromagnetic radiation. In the exemplary embodiment shown, for a separate configuration of the sensor nodes in the case of light-optical signaling, it would be necessary for the sensor nodes to be individually located in an optically tight environment for instance. In this case, the sensor nodes could each be selectively moved from the first operating state into the second operating state by means of a diffuse ceiling lighting. The diffuse light could be received and processed by way of the photo diodes 12.

It would likewise be possible for a plurality of sensor nodes to be moved into the second operating state by diffuse light.

In this case, the sensor nodes 2-4 could also be provided with means for determining a spectral characteristic of the diffuse ceiling lighting, with a sensor node only then being moved into the second operating state if the spectral characteristic of the ceiling lighting corresponds to a presettable spectral characteristic. Alternatively, the light could be modulated with a signal identifier, with the sensor nodes only then being moved from the first operating state into the second operating state if the signal identifier agrees with a preset signal identifier. Furthermore, the sensor nodes 2-4 could each be equipped with a photodiode, by means of which electrical energy can be obtained from the impacting light.

What is claimed is:

1-22. (canceled)

23. A method for operating a wireless sensor network comprising a plurality of sensor nodes, which are suitably configured to transfer data by means of nondirectional radio transmission, with it being possible for a selected set containing at least one sensor node to be moved selectively from a first operating state into a second operating state by means of a spatially delimited first operating state control signal, with the sensor nodes in the first operating state not being able to receive or at least process control data by means of nondirectional radio transmission and being able to receive and process control data in the second operating state by means of nondirectional radio transmission and with it being possible for the sensor nodes of the sensor network to be moved from a third operating state into the first operating state by means of a second operating state control signal, with the sensor nodes in the third operating state not being able to receive or at least process the first operating state control signal and in the first operating state being able to receive and process the first operating state control signal.

24. The method according to claim 23, wherein a sensor node for a presettable second time frame remains in the first operating state and is automatically moved into the third operating state after the second time frame has lapsed.

25. The method according to claim 23, wherein a sensor node in the first operating state is moved into the third operating state upon receipt of a second operating state control signal.

26. The method according to claim 23, wherein the first operating state control signal is sent in the form of a diffuse electromagnetic radiation in an environment which spatially delimits the electromagnetic radiation.

27. The method according to claim 26, wherein the first operating state control signal is sent in the form of a diffuse light transmission in an optically delimited environment.

28. The method according to claim 23, wherein the first operating state control signal is modulated with a selectable control signal identifier, which is demodulated by a sensor node receiving the first operating state control signal, with a sensor node being moved into the second operating state, if the first operating state is provided with the control signal identifier and not being moved into the second operating state, if the first operating state control signal is not provided with the control signal identifier.

29. The method according to claim 27, wherein a spectral characteristic of the first operating state control signal transmitted in the form of visible light is determined in a sensor node, with a sensor node being moved into the second operating state if the spectral characteristic of the first operating state control signal corresponds to a presettable spectral characteristic of the first operating state control signal and not being moved into the second operating state if the spectral characteristic of the first operating state control signal does not correspond to the presettable spectral characteristic for the first operating state control signal.

30. The method according to claim 27, wherein electrical energy in a sensor node is obtained from the first operating state control signal transmitted in the form of light.

31. The method according to claim 23, wherein the first operating state control signal is sent by means of nondirectional sound waves in an acoustically delimited environment.

32. The method according to claim 23, wherein a sensor node transmits a confirmation signal by means of nondirectional radio transmission after receipt of the first operating state control signal.

33. The method according to claim 32, wherein the first operating state control signal is sent from a signal sensor in the form of a signal pulse and that a time-resolved receipt of the confirmation signal takes place by the signal sensor.

34. The method according to claim 23, wherein a sensor node remains in the second operating state for a presettable first time frame and is automatically moved into the first operating state after the first time frame has lapsed.

35. The method according to claim 23, wherein a sensor node in the second operating state is moved into the first operating state upon receipt of a first operating state control signal.

36. The method according to claim 23, wherein the sensor nodes can be changed over by the first operating state control signal between a sensor-passive state, in which they do not scan data, and a sensor-active state, in which they scan data.

37. The method according to claim 23, wherein the first operating state control signal is sent from a mobile control device as a signal sensor.

38. The method according to claim 23, wherein the second operating state control signal is sent from a mobile control device as a signal sensor.

39. A sensor node which is provided with at least one sensor for scanning data, a transmitter-receiver for transmitting data by means of nondirectional radio transmission and a microprocessor-based control facility for controlling the sensor node, in which the control facility is suitably set up to
selectively move a selected set containing at least one sensor node from a first operating state into a second operating state by means of a spatially delimited first operating state control signal, wherein the sensor nodes in the first operating state are not able to receive or at least process control data by means of nondirectional radio transmission and are able to receive and process control data in the second operating state by means of nondirectional radio transmission and
to move sensor nodes of the sensor network from a third operating state into the first operating state by means of a second operating state control signal, wherein the sensor nodes in the third operating state are not able to receive or at least process the first operating state control signal and in the first operating state being able to receive and process the first operating state control signal.

40. A method for operating a wireless sensor network comprising a plurality of sensor nodes, which are suitably configured to transfer data by means of nondirectional radio transmission, the method comprising:
selectively moving a selected set containing at least one sensor node from a first operating state into a second operating state by means of a spatially delimited first operating state control signal, wherein the sensor nodes in the first operating state are not able to receive or at least process control data by means of nondirectional radio transmission and are able to receive and process control data in the second operating state by means of nondirectional radio transmission and
moving sensor nodes of the sensor network from a third operating state into the first operating state by means of a second operating state control signal, wherein the sensor nodes in the third operating state are not able to receive or at least process the first operating state control signal and in the first operating state being able to receive and process the first operating state control signal.

41. The method according to claim 40, wherein a sensor node for a presettable second time frame remains in the first operating state and is automatically moved into the third operating state after the second time frame has lapsed.

42. The method according to claim 40, wherein a sensor node in the first operating state is moved into the third operating state upon receipt of a second operating state control signal.
